(19) United States
(12) Patent Application Publication
(10) Pub. No.: US 2019/0320251 A1
(43) Pub. Date: Oct. 17, 2019

(54) MUSIC PLAYING FAN ASSEMBLY

(71) Applicant: Hind Mohammed, Yonkers, NY (US)

(72) Inventor: Hind Mohammed, Yonkers, NY (US)

(21) Appl. No.: 15/950,325

(22) Filed: Apr. 11, 2018

(51) Int. Cl. H04R 1/02; H04R 3/00; F04D 29/40; F04D 29/70; F04D 25/08; F04D 25/06

(52) U.S. Cl. CPC H04R 1/028; H04R 3/00; F04D 25/0673; F04D 29/703; F04D 25/08; F04D 29/403

(57) ABSTRACT

A music playing fan assembly for combining a radio with a fan includes a housing that is positionable on a support surface. The housing has an opening extending into an interior of the housing and the opening extends fully around the housing. A blower is coupled to the housing and the blower is in fluid communication with the opening. Moreover, the blower urges air outwardly through the opening when the blower is turned on to cool a user. An audio unit is coupled to the housing and the audio unit emitting audible sounds outwardly from the housing. Thus, the user can listen to the audible sounds while the fan is turned on or while the fan is turned off.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relates to fan devices and more particularly pertains to a new fan device for combining a radio with a fan.

### BRIEF SUMMARY OF THE INVENTION

An embodiment of the disclosure meets the needs presented above by generally comprising a housing that is positionable on a support surface. The housing has an opening extending into an interior of the housing and the opening extends fully around the housing. A blower is coupled to the housing and the blower is in fluid communication with the opening. Moreover, the blower urges air outwardly through the opening when the blower is turned on to cool a user. An audio unit is coupled to the housing and the audio unit emitting audible sounds outwardly from the housing. Thus, the user can listen to the audible sounds while the fan is turned on or while the fan is turned off.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a music playing fan assembly according to an embodiment of the disclosure.

FIG. 2 is a front view of an embodiment of the disclosure.

FIG. 3 is a right side view of an embodiment of the disclosure.

FIG. 4 is a schematic view of an embodiment of the disclosure.

### DETAILED DESCRIPTION OF THE INVENTION

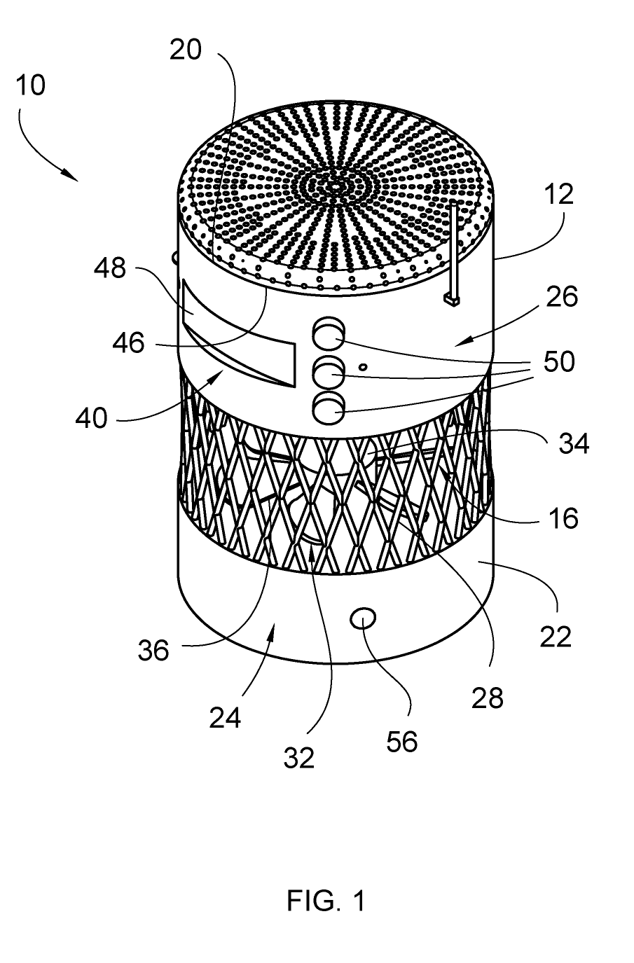

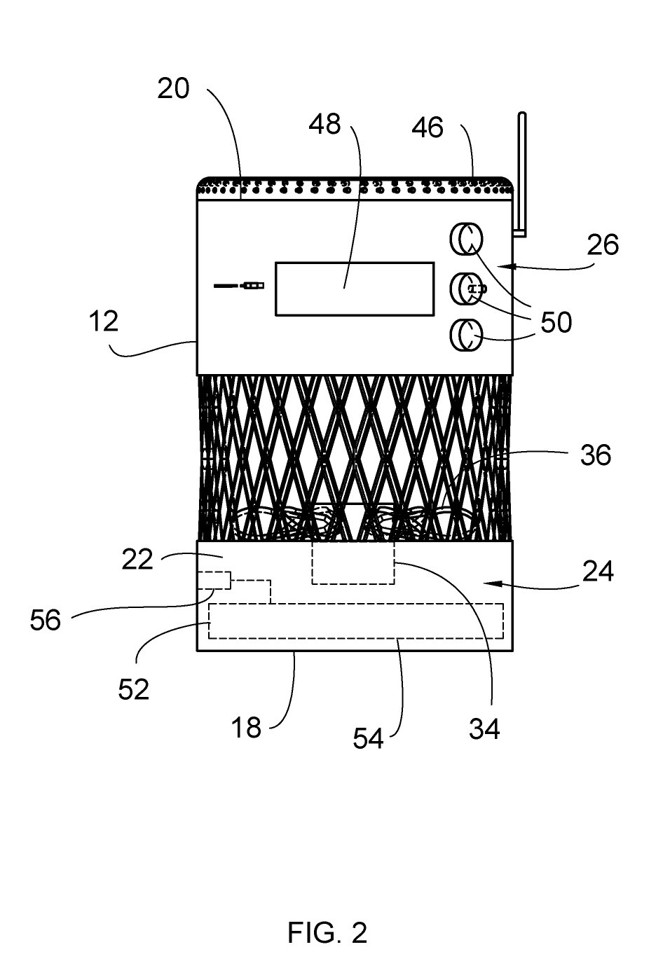

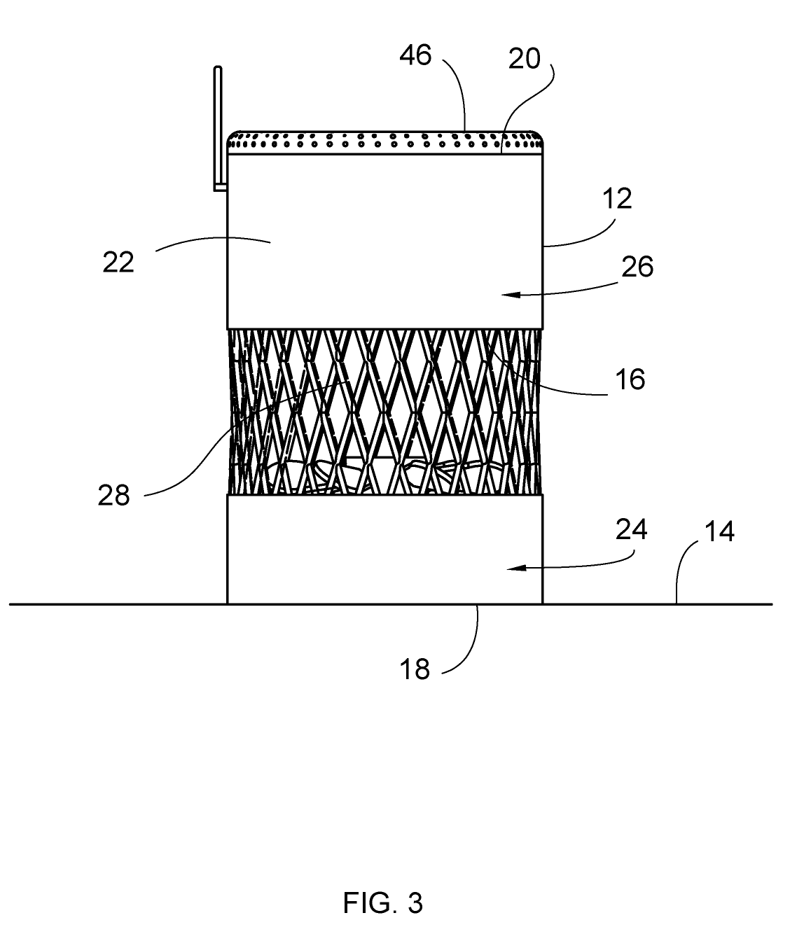

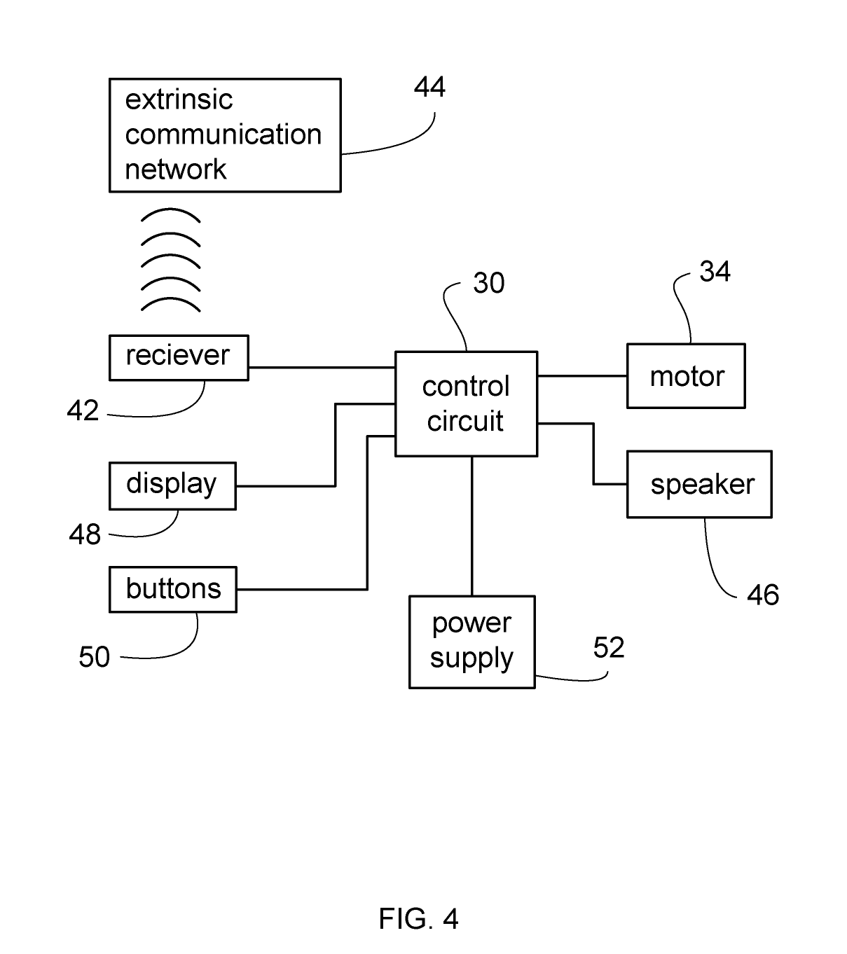

With reference now to the drawings, and in particular to FIGS. 1 through 4 thereof, a new fan device embodying the principles and concepts of an embodiment of the disclosure and generally designated by the reference numeral 10 will be described.

As best illustrated in FIGS. 1 through 4, the music playing fan assembly 10 generally comprises a housing 12 that is positionable on a support surface 14. The housing 12 has an opening 16 extending into an interior of the housing 12 and he opening 16 extends fully around the housing 12. The housing 12 has a bottom end 18, a top end 20 and an outer wall 22 extending therebetween. The outer wall 22 is continuously arcuate such that the housing 12 has a cylindrical shape and the opening 16 extends through the outer wall 22. Moreover, the opening 16 is continuous such that the opening 16 extends around a full circumference of the outer wall 22. Thus, the opening 16 defines a bottom portion 24 and a top portion 26 of the housing 12, and the opening 16 is positioned between the top end 20 and the bottom end 18. The housing 12 may have a height ranging between approximately 30.0 cm and 45.0 cm and a diameter ranging between approximately 15.0 cm and 30.0 cm.

A grill 28 is coupled between the top portion 26 of the housing 12 and the bottom portion 24 of the housing 12 and the grill 28 is coextensive with the opening 16. The grill 28 is comprised of a rigid material such as steel, plastic or the like, to support the top portion 26 of the housing 12 above the bottom portion 24 of the housing 12. A control circuit 30 is coupled to the housing 12 and the control circuit 30 may include a processor, plurality of integrated circuits and any other type of electronic control circuit 30.

A blower 32 is coupled to the housing 12 and the blower 32 is in fluid communication with the opening 16. The blower 32 is electrically coupled to the control circuit 30 and the blower 32 urges air outwardly through the opening 16 when the blower 32 is turned on. In this way the blower 32 blows air to cool a user when the user is outdoors or indoors. The blower 32 comprises a motor 34 that is coupled to the housing 12. The motor 34 is positioned within the housing 12, the motor 34 is electrically coupled to the control circuit 30, and the motor 34 may be an electric motor 34 or the like. Additionally, the motor 34 may be attached to the bottom portion 24 of the housing 12.

A fan 36 is coupled to the motor 34 such that the motor 34 rotates the fan 36 when the motor 34 is turned on. The fan 36 is aligned with the opening 16 such that the fan 36 urges air outwardly through the opening 16 when the motor 34 is turned on. A blower power button 38 is coupled to the housing 12. The blower power button 38 is electrically coupled to the motor 34 such that the blower power button 38 turns the motor 34 on and off.

An audio unit 40 is provided and the audio unit 40 is coupled to the housing 12. The audio unit 40 emits audible sounds outwardly from the housing 12 to facilitate the user to listen to the audible sounds. The audible sounds may be music and the music may be received from an AM/FM radio station or the like. The audio unit 40 is electrically coupled to the control circuit 30.

The audio unit 40 comprises a receiver 42 that is coupled to the housing 12. The receiver 42 is electrically coupled the control circuit 30 and the receiver 42 is in electrical communication with an extrinsic communication network 44 to receive electromagnetic signals from the extrinsic communication network 44. The receiver 42 may be a radio frequency receiver or the like and the extrinsic communication network 44 may be a public radio station, a wifi router and any other communication network that broadcasts an electromagnetic signal. Moreover, the receiver 42 may include an antenna that is mounted to the housing 12.

A speaker 46 is coupled to the top end 20 of the housing 12 and the speaker 46 is electrically coupled to the control circuit 30. The speaker 46 converts the electromagnetic signals from the receiver 42 into audible sounds for broadcasting the audible sounds. Additionally, the speaker 46 may be an electronic speaker 46 of any conventional design. A display 48 is coupled to the outer wall 22 of the housing 12 and the display 48 is electrically coupled to the control circuit 30. The display 48 displays indicia comprising numbers that indicate a tuned frequency and other operational parameters of the receiver 42. The display 48 may be an LCD or the like. A plurality of buttons 50 is coupled to the outer wall 22 of the housing 12 and each of the buttons 50 is electrically coupled to the control circuit 30 to control operational parameters of the receiver 42 and the speaker 46.

A power supply 52 is coupled to the housing 12 and the power supply 52 is electrically coupled to the control circuit 30. The power supply 52 comprises at least one rechargeable battery 54 that is removably positioned within the housing 12. A charge port 56 to is coupled to the housing 12 and the charge port 56 is electrically coupled to the at least one rechargeable battery 54. The charge port 56 is selectively and electrically coupled to a power source for charging the at least one rechargeable battery 54. The power source may be a battery charger, a female electrical outlet and any other source of electrical current.

In use, the housing 12 is placed on the support surface 14, such as the ground when the user is outside, a table when the user is in inside and any other support surface 14. The blower power button 38 is depressed to turn the motor 34 on to blow air outwardly from the housing 12. Thus, the fan 36 blows air onto the user to cool the user. The buttons 50 are manipulated to turn the receiver 42 and speaker 46 on to emit the audible sounds. In this way the user can listen to music or other broadcast while simultaneously being cooled by the fan 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A music playing fan assembly combining elements of a fan for blowing air and a radio for playing music, said assembly comprising:
a housing being positionable on a support surface, said housing having an opening extending into an interior of said housing, said opening extending fully around said housing;
a control circuit being coupled to said housing;
a blower being coupled to said housing such that said blower is in fluid communication with said opening, said blower being electrically coupled to said control circuit said blower urging air outwardly through said opening when said blower is turned on wherein said blower is configured to cool a user; and
an audio unit being coupled to said housing, said audio unit emitting audible sounds outwardly from said housing wherein said audio unit is configured to facilitate the user to listen to the audible sounds, said audio unit being electrically coupled to said control circuit.

2. The assembly according to claim 1, further comprising said housing having a bottom end, a top end and an outer wall extending therebetween, said outer wall being continuously arcuate such that said housing has a cylindrical shape, said opening extending through said outer wall, said opening being continuous such that said opening extends around a full circumference of said outer wall to define a bottom portion and a top portion of said housing, said opening being positioned between said top end and said bottom end.

3. The assembly according to claim 2, further comprising a grill being coupled between said top portion of said housing and said bottom portion of said housing, said grill being coextensive with said opening, said grill being comprised of a rigid material to support said top portion of said housing above said bottom portion of said housing.

4. The assembly according to claim 2, wherein said blower comprises a motor being coupled to said housing, said motor being positioned within said housing, said motor being electrically coupled to said control circuit.

5. The assembly according to claim 4, further comprising a fan being coupled to said motor such that said motor rotates said fan when said motor is turned on, said fan being aligned with said opening such that said fan urges air outwardly through said opening when said motor is turned on.

6. The assembly according to claim 5, further comprising a blower power button being coupled to said housing, said blower power button being electrically coupled to said motor such that said blower power button turns said motor on and off.

7. The assembly according to claim 2, wherein said audio unit comprises a receiver being coupled to said housing, said receiver being electrically coupled said control circuit, said receiver being in electrical communication with an extrinsic communication network wherein said receiver is configured to receive electromagnetic signals from the extrinsic communication network.

8. The assembly according to claim 7, further comprising a speaker being coupled to said top end of said housing, said speaker being electrically coupled to said control circuit, said speaker converting the electromagnetic signals from said receiver into audible sounds for broadcasting the audible sounds.

9. The assembly according to claim 8, further comprising a display being coupled to said outer wall of said housing, said display being electrically coupled to said control circuit, said display displaying indicia comprising numbers indicating a tuned frequency and other operational parameters of said receiver.

10. The assembly according to claim 9, further comprising a plurality of buttons, each of said buttons being coupled to said outer wall of said housing, each of said buttons being electrically coupled to said control circuit, each of said buttons controlling operational parameters of a respective one of said receiver and said speaker.

11. The assembly according to claim 2, further comprising a power supply being coupled to said housing, said power supply being electrically coupled to said control circuit, said power supply comprising:
at least one rechargeable battery being removably positioned within said housing; and
a charge port to being coupled to said housing, said charge port being electrically coupled to said at least one rechargeable battery, said charge port being selectively and electrically coupled to a power source for charging said at least one rechargeable battery.

12. A music playing fan assembly combining elements of a fan for blowing air and a radio for playing music, said assembly comprising:
a housing being positionable on a support surface, said housing having an opening extending into an interior of said housing, said opening extending fully around said housing, said housing having a bottom end, a top end and an outer wall extending therebetween, said outer wall being continuously arcuate such that said housing has a cylindrical shape, said opening extending through said outer wall, said opening being continuous such that said opening extends around a full circumference of said outer wall to define a bottom portion and a top portion of said housing, said opening being positioned between said top end and said bottom end;
a grill being coupled between said top portion of said housing and said bottom portion of said housing, said grill being coextensive with said opening, said grill being comprised of a rigid material to support said top portion of said housing above said bottom portion of said housing;
a control circuit being coupled to said housing;
a blower being coupled to said housing such that said blower is in fluid communication with said opening, said blower being electrically coupled to said control circuit said blower urging air outwardly through said opening when said blower is turned on wherein said blower is configured to cool a user, said blower comprising:
a motor being coupled to said housing, said motor being positioned within said housing, said motor being electrically coupled to said control circuit;
a fan being coupled to said motor such that said motor rotates said fan when said motor is turned on, said fan being aligned with said opening such that said fan urges air outwardly through said opening when said motor is turned on; and
a blower power button being coupled to said housing, said blower power button being electrically coupled to said motor such that said blower power button turns said motor on and off; and
an audio unit being coupled to said housing, said audio unit emitting audible sounds outwardly from said housing wherein said audio unit is configured to facilitate the user to listen to the audible sounds, said audio unit being electrically coupled to said control circuit, said audio unit comprising:
a receiver being coupled to said housing, said receiver being electrically coupled said control circuit, said receiver being in electrical communication with an extrinsic communication network wherein said receiver is configured to receive electromagnetic signals from the extrinsic communication network;
a speaker being coupled to said top end of said housing, said speaker being electrically coupled to said control circuit, said speaker converting the electromagnetic signals from said receiver into audible sounds for broadcasting the audible sounds;
a display being coupled to said outer wall of said housing, said display being electrically coupled to said control circuit, said display displaying indicia comprising numbers indicating a tuned frequency and other operational parameters of said receiver;
a plurality of buttons, each of said buttons being coupled to said outer wall of said housing, each of said buttons being electrically coupled to said control circuit, each of said buttons controlling operational parameters of a respective one of said receiver and said speaker; and
a power supply being coupled to said housing, said power supply being electrically coupled to said control circuit, said power supply comprising:
at least one rechargeable battery being removably positioned within said housing; and
a charge port to being coupled to said housing, said charge port being electrically coupled to said at least one rechargeable battery, said charge port being selectively and electrically coupled to a power source for charging said at least one rechargeable battery.
